(19) United States
(12) Patent Application Publication
(10) Pub. No.: US 2025/0008307 A1
(43) Pub. Date: Jan. 2, 2025

(54) SYSTEM AND METHOD FOR E-BONDING ARCHITECTURE

(71) Applicant: Tangoe US, Inc., Stamford, CT (US)

(72) Inventors: Chaitanya Ravindra Kulkarni, Austin, TX (US); Ronald Gerald Michaud, Goffstown, NH (US); Vijayasree Pera, Aldie, VA (US)

(73) Assignee: Tangoe US, Inc., Stamford, CT (US)

(21) Appl. No.: 18/755,603

(22) Filed: Jun. 26, 2024

Related U.S. Application Data
(60) Provisional application No. 63/524,075, filed on Jun. 29, 2023.

(51) Int. Cl. H04W 4/24; H04L 41/50

(52) U.S. Cl. CPC H04W 4/24; H04L 41/5058

(57) ABSTRACT

A system and method for normalizing telecommunications expense management and carrier system interactions including normalizing order entry information from multiple source systems and providing a standard intermediary format that can be again converted to multiple output or target systems which in turn provide order status information that is also normalized and sent back to the source systems thus providing a consistent ordering experience regardless of source system used or target system that actually fulfils the orders.

### CROSS REFERENCE TO RELATED APPLICATIONS

This application claims priority to U.S. Provisional patent application No. 63/524,075 filed Jun. 29, 2023, the contents of which are incorporated by reference.

### FIELD OF THE INVENTION

The present invention relates to systems and methods which allow added input and output telecom systems, namely telecom expense management TEM and carrier systems to be cross compatible with existing systems. The system is capable of receiving inputs from multiple input source systems, converting these into a normalized intermediate format, and then converting these to multiple output formats to match the specific requirements of one or more output systems is presented so that use of and addition of input/output systems is streamlined and cross compatible.

### BACKGROUND OF THE INVENTION

Large enterprises often use telecommunications expense management TEM systems to procure, fulfill and provision various telecommunications devices within the enterprise. Often, the enterprise is looking for ways to save money while still delivering the necessary telecommunications devices and capabilities for productivity within the enterprise. This may involve switching telecom plans with a carrier or even switching carriers. However, each telecom expense management system often has different features and options available and different ways to allow individuals to obtain devices and plans that suit them with various options and rules available to manage the enterprise's expenses. Similarly, each carrier will change and update their offerings and thus the TEM system needs to be updated to work with the updated carrier system.

In some cases, a different expense management system will provide better options and the enterprise will want to switch to different expense management systems i.e. the input and in other cases, the addition of new carriers or options may require additional output systems to be integrated with the input system.

The challenge is that cross compatibility when adding or switching systems does not come automatically. Each system has different input requirements, different data structures and then each carrier will usually have different data structures to receive orders and plan/provision requests to then receive the output from the TEM system outputs. Thus, when the input system TEM system has features added, these need to be made to work with each carrier and when carriers have different updates or changes, these need to work with each input system. If there are 10 carriers and 10 input systems, one change in each can be come 100 different changes to the software to make the whole system function as the system architecture for the interface between each TEM system and the carriers is often unique to that TEM system.

The challenges are compounded for telecom expense management companies that offer services across multiple enterprises with many systems.

To simplify the order process, many such telecom expense management companies provide their own order entry systems allowing customers to utilize simple mobile or web order forms for procurement of their devices.

These systems may have built in logic to allow companies to put in place a preferred selection of devices and plans. They may incorporate approval flows that tailor the procurement process to meet a company's needs. Example: Managers may be allowed a $1,000 phone while front line workers may only be allowed a $500 phone, salespeople may be automatically configured with a roaming plan whereas office workers may have a smaller allocation of minutes without roaming.

While these customer facing systems simplify the telecom expense management companies order entry process and make the buying experience simple and customizable for the client, once the order is entered into the TEM system, there remains the actual fulfillment process with one or more service providers or carriers that must be done.

What could be a text field in one system can be a pull-down menu in another, or the selections may vary in abbreviation or nomenclature. The order for an iPhone 14 may become a pull-down selection in one system, it may have to be entered as text in another and may be the number 8 in a list of 15 device selections in a third. And various changes to input/output systems need to be fixed multiple times for the various updates to each system.

While some screen mapping solutions have been employed, these break when new options are added or when the systems in use are modified and updated. With today's agile development and rapid rollouts of new features and functions, these updates and changes are increasingly frequent.

In still other cases, service provider systems offer application programming interfaces APIs which have been adopted and integrated with the source system from the telecom expense provider.

The large telecom expense management provider that may have clients in multiple countries with multiple carriers. Here, while the TEM provider will want to offer a consistent approach to ordering in the source order system it presents to its clients, the target systems provided by the carriers will be different and will have different order processing interfaces. Some may not have interfaces at all. The adaptation of the input order to the various target systems is a requirement of the TEM system.

Further adding to the complexity, a telecom expense management provider that may have various input systems. This may be due to obtaining systems and clients through acquisition or may simply be different offerings to suit different client needs. Rather than recreate the normalization logic for the target systems, the ability to collect the orders from the varied systems and normalizing the input of orders is also something that would simplify the overall order process for such a telecom expense provider by having a consistent normalized input order regardless of which system was used to enter it, and regardless of which carrier or service provider the order was destined for.

U.S. Pat. No. 8,433,618 from Marsh described telecom expense management procurement services but focuses more on the logistics of adding and configuring devices for the end user and does not address the capability to normalize multiple input order streams and multiple output order streams as described herein.

U.S. Pat. No. 8,732,023 by Mikurak envisions a system that would allow a source system to communicate in a standard way with multiple telecom carrier systems but dictates the methodology. Such an approach is not realistic in expecting the telecom providers to adapt and adhere to an integration specification based on TEM systems requirements. Further, Mikurak does not describe multiple source input systems or a normalization software layer capable of adapting to the multiple inputs and output systems as described herein.

Accordingly, it would be beneficial to have a system and method to normalize input streams from multiple source systems in such a way as to capture sufficient information for carrier order placement in the output systems to ensure cross compatibility.

It would further be beneficial to have a system and method that can take such normalized intermediary data describing orders and convert it again to one or more target carrier systems to place orders in such a target carrier system.

It would be still further beneficial to have a system and method that could retrieve status information from a multitude of carrier procurement systems and normalize such status information such that it can be provided to the source order entry system in a format recognizable by such systems.

Therefore, a need exists for a system and method to provide a normalization layer for multiple order entry systems for a telecom expense management provider to place orders in multiple target carrier systems and to gather status information from the multiple target carrier systems and provide this back to the initiating order entry system in the appropriate format.

### SUMMARY OF THE INVENTION

Accordingly, it is desired to provide a system and method that is able to collect and normalize orders from a multitude of input/source systems provided for placing telecom orders.

It is also desired to provide a system and method that is able to normalize these orders into an internal intermediary format that contains all the data required to identify the source system, the one placing the order, along with the order details and the output/target system for order placement.

It is still further desired to provide a system and method that can convert the normalized order data into one or more target carrier system data formats in order to place the order along with the logic to interface with the target system and place the order.

It is still further desired to provide a system and method that is able to retrieve order status information from the target carrier system, convert this status information into a normalized intermediary format and identify the target order placement system as well as the one having placed the order and convert this status information to the format expected by the identified source system and relay it back to the individual having placed the order. This status retrieval may be requested by the individual or it may be provided by the target carrier system upon status change or at fixed times.

It is still further desired to provide a system and method that is able to offer a consistent ordering interface to a multitude of order entry systems allowing for the interfacing of a variety of order entry systems to customers such that these order entry systems can talk with multiple carriers without concerning themselves with the complexities of interfacing with the multiple carrier systems.

Further, it is an object to provide a system that allows for consistent cross compatibility and compatibility updates across multiple input/output systems so that as updates are made to the system of an input or output system in terms of e.g. data structures and options, the interface with the software system e.g. the input system can be updated to then allow with compatibility with all other output systems with just one update to the input system compatibility without updating all input systems. The same holds true to output system updates of one system being compatibility with all other input systems, again without updating all input systems individually for output system compatibility.

In one configuration, an order receiving system is provided that includes a computer having software executing thereon where the software comprises a TEM engine that receives the client orders and places these in an order queue. These orders may include, but are not limited to, the description of the equipment being ordered, identifying information of where devices are to be shipped, the receiver, as well potentially billing information. Status information may include such data such as stock levels, expected ship times and tracking information.

The TEM system is provided with the ability to automatically normalize the input data into a format that is consistent with the data needed to place the order with one or more carrier systems.

As an example, in one instance a carrier system may require the entry of a 5-digit zip code whereas another carrier may require the entry of a 10-digit zip code including the 4-digit suffix used in the US mail system. In such a case, the 10 digits are used and stored by the system and the input format is automatically converted for the target system in hand.

As another simple example, the name may be a 40-digit field in the carrier system buy may have been entered as an 80-digit alphanumeric field in the source system. In another carrier system all 80 digits may be allowable. In such a case the system will truncate the data or attempt an address validation and conversion reducing common names such as Boulevard, to Blvd or Road to Rd and so on. The key point being that there is no specific adaptation required for the one or more source systems in order to communicate with the one or more target carrier systems.

As a first step, normalization of the data from the various input systems is performed to generate a baseline order entry set of structures which includes a superset of data which is enterable by the one or more source systems. This data adaptation is also learned through the interface of new order entry systems in that if a new system is connected, the new structures, should they include new data fields, are also automatically added to the internal super-set data structures.

As a second step, the data used for the order entry must conform and provide sufficient detail to the one or more target carrier systems used to place the order. In such cases that the target systems require additional data not entered by the source system, this data is also included in the structures describing the super set of data used by the system. For example, even if the input order entry system or systems does not include the currency used or the preferred language which may be a requirement from the target carrier system, these are added, and default values are used or derived by the system based on location or shipping address or billing address.

As a third step, when placing the order in the one or more carrier systems, a logic flow of how to place the order and acknowledge and validate the order is performed which may be unique to each of the one or more carrier systems. As an example, one system may simply accept the order and provide a confirmation number right away, another system may wait until the order is internally verified and provide a confirmation with more order details, such as the expected shipping date and perhaps the serial number of the device to be shipped.

Other possible scenarios regarding the order acknowledgement may be more complex. One target carrier system may simply accept the order but not provide an acknowledgement at all requiring the system to poll for status until such time as the order can be confirmed.

Yet another target carrier system may provide a call back function which will make a procedure call back to the system when the order can be confirmed.

For each of these cases, logic in the system is provided such that the choice of end carrier systems is transparent and seamless to the order entry source system. Using the set of structures that contain the super set of data, the data is appropriately formatted for the target carrier and the interface logic is conformed to so as to place the order.

It should also be noted that while the examples described above are simplistic in nature, each case must also include logic for exception handling and recovery logic that may include retries, status queries and even reporting back to the source system with backorder data or order cancellation. A myriad of such examples could be listed but would be obvious to those knowledgeable with such programming interfaces. Just to name a few, we must consider what must be done if the carrier system does not respond, this may be a timer that causes a retry or an exception handling situations such as how the system reacts after a failed credit card, an invalid address, an out-of-stock situation.

Continuing on as a fourth step, status information may be gathers from the target carrier system through the appropriate programming interface. The methods of obtaining the status information, the type of data supplied is also unique to the target carrier system that is receiving the order. The status information is normalized in a similar fashion as the orders, where a super set structure is formed for the status information which may be available across all known target carrier systems is formed. Further, the superset is expanded to include the necessary or expected fields for reporting the status to the one or more order entry systems that initiated the order. So similar to the order flow from the source order entry system s to the target carrier systems, the flow is reversed, and the data is normalized in the opposite direction.

Finally, as a fifth step, the super set of data representing the status information is used to create the status response in the appropriate format for the source system that placed the order, and the status is provided. This may be in response to the placement of the order, with statuses such as order acknowledged and may contain information about the order as supported by the source order entry system. It may also be provided by callback to the source system if supported, it may be provided in response to a status query by the source system. The interface with the source system to provide the status information is also unique to the source system being used and the system described provides this data in a seamless manner. The advantages of the approach outlines should be obvious as it allows for the seamless interfacing of one or more source systems to place orders across one or more target carrier systems. It allows one or more carrier systems to provide order status to one or more source order entry systems in a seamless way.

Benefits include making a change of the source order entry system seamless for a customer. In the past, once entrenched, these order entry systems were difficult to dislodge as they formed an integral part of an important function within the organization and were interfaces with a variety of other systems. Allowing the seamless adaptation of data across systems make them closer to plug and play allowing customers better leverage in negotiating pricing or changing providers for improved products should they choose to do so.

Additional benefits include the ability to change carriers for order placement as well. With a seamless interface to the target carrier systems the customer also has leverage over pricing and may dynamically move orders from one carrier to another without any change to how orders are placed in the source system.

Finally, the interfacing of new systems is simplified as the system provides an interface methodology describing the structures used to create its super set of data. No knowledge by the input systems of interface requirements with the target carrier systems is required, instead, the input systems are already set up with the requirements via the software program that uses the super set of data and only the new output carrier system or updates thereto need to be interfaced once with the software program. In this way, the addition/update of one output carrier system now works with all input systems. Thus, the improved system architecture of how input and output systems communicate allows for significant efficiencies. New input systems can be integrated with ease to work with existing carriers and new carriers can be integrated with ease to work with existing input systems in a similar fashion. Further, those wanting to create their own entry systems are able to do so in a rapid fashion as the interface requirements are simplified to providing the structure and reporting the status in a consistent manner.

For this application the following terms and definitions shall apply:

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “process” and “processing” as used herein each mean an action or a series of actions including, for example, but not limited to, the continuous or non-continuous, synchronous, or asynchronous, routing of data, modification of data, formatting and/or conversion of data, tagging or annotation of data, measurement, comparison and/or review of data, and may or may not comprise a program.

The term “customer” as used herein means any company, user, or third party receiving a service from a provider, for which an established agreement has been negotiated.

The term “vendor” as used herein means any entity such as a service provider, a manufacturer, or a 3^{rd} party, or other entity providing services.

In one configuration a system for gathering customer orders, the system comprising a computer having a storage and a network connection and software executing on the computer comprising an order entry system automatically capturing and recording orders from one or more target order entry systems as they are entered. The order entry system using methods to adapt the order entry system specific data formats to a superset internal structure.

In another configuration, a method for placing vendor orders in one or more target carrier systems is provided, the method comprising the steps of automatically contacting the target carrier system through API potentially with a Robotic Process Automation RPA bot executing on a computer via a network connection, presenting site access credential information to the site with the RPA bot, which when authenticated enables the RPA bot to access the site, and accessing events and steps in a process required to fulfil the order, a subpart of the order processing event being addressed by the system.

In yet another configuration, a method for gathering status from the vendor order system by an RPA bot is provided, the method comprising the steps of automatically contacting the site with an RPA bot executing on a computer via a network connection, presenting site access credential information to the site with the RPA bot, which when authenticated enables the RPA bot to access the site, and accessing events and steps in a process required to fulfil a subpart of the order processing status gathering event being addressed by the system.

In all cases, the association of the data received with contextual order information is key to the automatic nature of the system to gather and compare data as well as to make decisions based on the data analysis. In one configuration, a database or look up table of data is provided where diverse information is gathered and automatically normalized allowing the system to then automatically compare similar data using diverse identifiers. Once data is identified and grouped according to the raw order parameters, data can be appended to a superset structure to associate it with commonly used terms by the order system through the use of self-learning.

Therefore, the foregoing and other objects of the invention are achieved by providing a system for multiple input and output system interfacing for telecommunications services and devices. A computer is provided with interface software executing thereon which is in communication with software of a plurality of input systems which input systems each relate to a telecommunications expense management (TEM) system and which is in communication with software of a plurality of output systems which output systems each relate to a telecommunications service provider system. The software of each input system provides access to a TEM computer which provides user access for procuring telecommunications devices and telecommunications service plans. The software of each output system is interfaced with a telecommunications service provider computer which fulfills telecommunications device and/or service orders. Upon modification of the interface software with an input change for the input system due to a change to the software of one or more of the input systems, said interface software automatically interfaces with each output system such that each of the output systems is compatible with the input change such that information from the input system subject to the input change is converted by the interface software to be compatible with each output system. Furthermore, upon modification of the interface software with an output change due to a change to the software of one or more of the output systems, said interface software automatically interfaces with each input system such that the input system is compatible with the output change such that information from the output system subject to the output change is converted by the interface software to be compatible with each input system.

In certain aspects the input change allows the service provider computers to communicate with the TEM computer in a form matched to that TEM computer. In other aspects the input change allows the service provider computers to communicate with the TEM computer in a form matched to that TEM computer. In other aspects the information from the input system is indicative of a telecommunications device or service order. In yet other aspects information from the output system is indicative of a confirmation for a telecommunications device or service order. In yet other aspects information from the input system is indicative of request to modify a telecommunications service plan. In still other aspects the interface software is configured to access a mapping storage having mapping data which mapping data indicates how data received from each input system is correlated to data to be sent to each output system. In yet further aspects the input change results in a modification to the mapping data. In yet other aspects, the interface software further comprises messaging software which provides a status queue and order queue for statuses and orders which are to be sent to the corresponding one(s) of the plurality of input and output systems, the messaging software correlating the received statuses and orders to the appropriate component of the interface software.

Other objects of the invention are achieved by providing a system for interfacing a telecommunications expense management (TEM) input system with a plurality of telecommunications service provider output. The system includes an interface computer in communication with a telecommunications expense management (TEM) computer and a plurality of service provider computers, the interface computer comprising software executing thereon which software provides a communications interface between the TEM computer and each of the service provider computers to allow inputs into the TEM computer for one or more of the service provider computers to be received by the interface computer and transmitted to one or more of the service provider computers in a form matched to the service provider computer receiving the input(s) such that a change to the communications interface between the TEM computer and the interface computer allows the TEM computer to communicate with each of the service provider computers in the form matched to that service provider computer.

In certain aspects the change to the communications interface between the service provider computer and the interface computer allows the service provider computers to communicate with the TEM computer in a form matched to that TEM computer. In other aspects the inputs from the input system are indicative of a telecommunications device or service order. In other aspects the interface software is configured to access a mapping storage having mapping data which mapping data indicates how data received from each input system is correlated to data to be sent to each output system. In further aspects the change to the communications interface results in a modification to the mapping data.

Yet other objects are achieved by providing a system for interfacing a telecommunications service provider output system with a plurality of telecommunications expense management (TEM) input systems. An interface computer is in communication with a plurality of telecommunications expense management (TEM) computers and a service provider computer, the interface computer comprising software executing thereon which software provides a communications interface between the TEM computers and the service provider computer to allow inputs into the TEM computer for one or more of the service provider computers to be received by the interface computer and transmitted to one or more of the service provider computers in a form matched to the service provider computer receiving the input(s) such that a change to the communications interface between the service provider computer and the interface computer allows the TEM computer to communicate with each of the service provider computers in the form matched to that service provider computer.

In certain aspects the change to the communications interface between the TEM computers and the interface computer allows the TEM computers to communicate with the service provider computer in a form matched to that service provider computer. In yet other aspects the inputs from the input system are indicative of a telecommunications device or service order. In still other aspects the interface software is configured to access a mapping storage having mapping data which mapping data indicates how data received from each output system is correlated to data to be sent to each input system. In further aspects the change to the communications interface results in a modification to the mapping data.

Other objects of the invention and its features and advantages will become more apparent from consideration of the following drawings and accompanying detailed description.

### BRIEF DESCRIPTION OF THE DRAWINGS

FIG. 1 is a simplified context diagram of the relationships involved in the interface/e-bonding system.

FIG. 2 shows an example of how the input flow of orders requests are processed from the client side to the vendor side.

FIG. 3 shows an example of the response processing or return flow of status information and order updates from the vendor back to the client.

FIG. 4 shows an example of the response processing or return flow of status information and order updates from the vendor back to the client.

FIG. 5 Shows an example of the E-Bonding Input System Interface Details Variances for order placement.

FIG. 6 Shows an example of the E-Bonding New Solution interface methodology.

FIG. 7 shows an example carrier side interface.

FIG. 8 shows an example of the machine learning/automation process.

### DETAILED DESCRIPTION OF THE INVENTION

Referring now to the drawings, wherein like reference numerals designate corresponding structure throughout the views, the following examples are presented to further illustrate and explain the present invention and should not be taken as limiting in any regard.

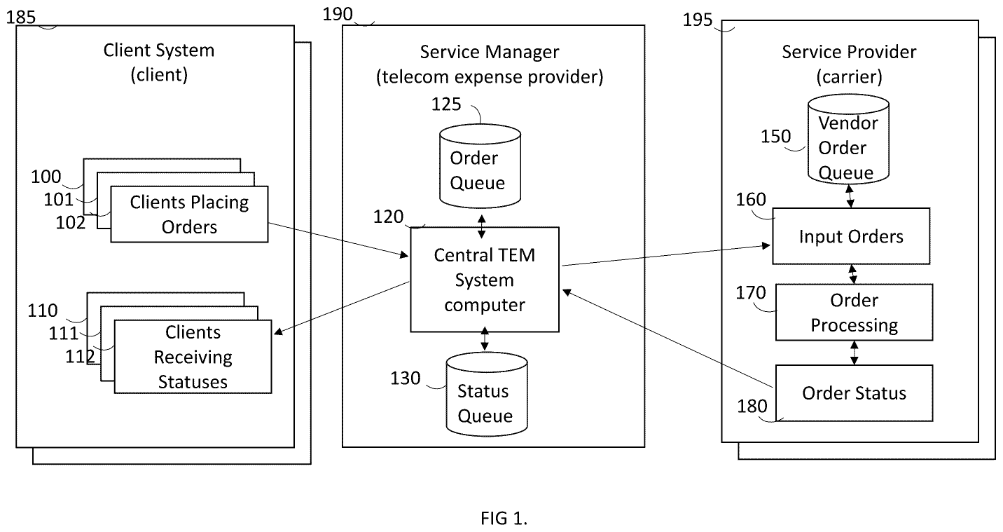

Referring to FIG. 1 a simplified context diagram of the actors and relationships between them is shown. First, we identify the client system 185 or the consumer where orders are placed and statuses displayed. This is typically a traditional TEM system that would ordinarily be directly integrated with a variety of carriers and provide a variety of offerings for obtaining telecom services. The client system 185 is provided by a computer with software executing thereon that will often provide a user interface allowing the clients to place orders 100-102. Second, the service manager 190 is shown where the orders are received and processed. This service manager 190 is provided by a computer with software executing thereon, the software is arranged to interface with the client's 185 and the providers 195. Third, the service provider 195 or carrier is shown where the orders come in using the specific carrier formats and they are processed and fulfilled. This carrier system 195 is also provided by a computer with software executing thereon, the carrier system, and all of the systems 185, 190, 195 have network connections in order to communicate with the appropriate other computer. It should be noted, that in some instances, the service provider 195 may fulfill orders sending them directly to the client 185, but in other cases these may flow through the service manager or TEM provider 190 as illustrated. In some cases, TEM provider 190 may preconfigure the devices by adding applications, putting them on a device management system, or installing a corporate VPN. They may also bundle accessories or other corporate items that go to new hires or that might complement the device such as protective cases, hands free driving accessories or headsets.

Looking at the Client system 185, there may be multiple clients placing orders 100, 101, 102. This depiction is intended to reflect multiple employees in a company that may be using the portal or application for ordering that is provided by the TEM provider 190 to enter data. Consider this the client system 185 account on the TEM provider 190 system with each of the order placements 100, 101, 102 being individuals in that organization logged in and placing orders. Furthermore, there are multiple client system 185 as well as multiple carriers 195. The service manager 190 sits between these systems to interface between the two. Although a traditional architecture may allow the client system 185 to interface with multiple carriers 195, this becomes inadequate when there are multiple client system and multiple carriers, each requiring interfacing with the other. This becomes especially problematic when there is a carrier update that changes the interfacing in some way. In this scenario under the traditional architecture, each client system 185 needs to be updated with the new interface for the carrier who changed. If there are 10 different client systems 185, each client system needs to be re-programmed or otherwise re-interfaced to continue to work or to provide the new offering. However, with the service manager 190 between the client 185 and service provider 195 systems, the carrier update can be pushed/interfaced with the service manager 190 once and this automatically interfaces with all client systems 185. The reverse is true with regards to client system 185 updates which can be interfaced to the service manager 190 once for each client which then pushes/interfaces automatically with each carrier. Particularly, each of the multiple client systems 185 may be different for different clients or even one client may use different client systems for different purposes.

The information in the orders 100, 101,102 flows to the TEM system 120 where the data is verified and placed into an order queue 125. The central TEM system 120 processed the order queue 125 and sends a request to the service provider 195 system by placing the order in the input orders 160 of the service providers 195 which in turn places it in its own internal order queue 150. It should be noted that while we are describing a single request, bursts of requests from many users may come in and the input flow of orders may be faster than the ability of the system to place orders in the service provider 195 inputs queues 160, 150. Further, it is possible that the service provider 195 input order 160 system becomes unavailable and thus orders that are queued up 125 are held until the system 160 becomes available again.

Once the service provider 195 system is able to do so, the orders are taken from the order queue 150 processed 160, 170 and order status 180 is generated which is sent to the TEM system 120 of the Service manager or telecom expense management provider 190. This status information flows from the central TEM system 120 into a queue of status information 130 and is sent back to the client system 185 or client s 110, 111, 112.

The system is designed specifically for the cases where there are multiple client systems 185 which makes the mapping of the orders placed 100, 101,102 in the client system 185 to the central TEM system a key advantage. The central TEM system includes software executing thereon which provides the conversion from the one or more client systems 185 into a normalized format which can be queued in the order queue 125 and processed and sent to the service provider or carrier 195 system as the central TEM system computer and software 120 is already interfaced with each of the carriers.

the central TEM system 120 of the Service Manager or Telecom Expense Provider 190 will take the normalized order data from the order queue 125 and format this to the specific requirements and format of the input orders 160 system of each service provider 195. Thus, the central TEM system computer provides what may be referred to as an e-bonding system.

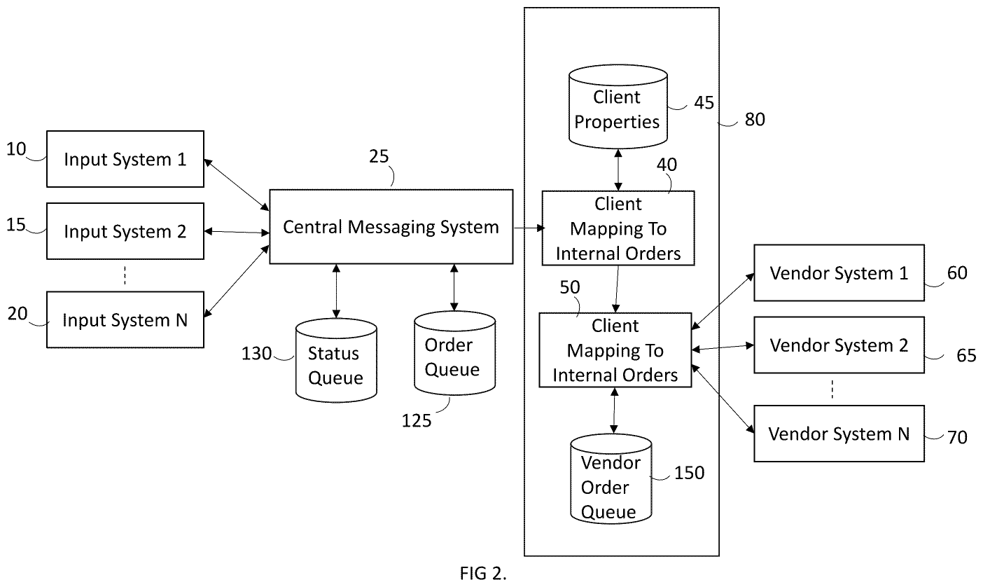

Turning now to FIG. 2 we see the e-bonding request processing system 80 (sometimes to referred to as the interfacing system or interface software) mapping client to vendor requests. In FIG. 2 we are presented with multiple input systems 10, 15, 20 which should be envisioned as separate software platforms used to enter data from a corporate account. Each of the systems 10, 15, 20 are representative of the Client system depicted in FIG. 1 185 and will have multiple individual consumers that are part of that corporate organization that may be placing orders. The main point is that each of the input systems 10, 15, 20 in this case will have different order formats to represent those orders being made.

These differences can consist of additional fields that the input system 10, 15, 20 require to enter orders. They may have approval status, with or without approver information. The data may be of different formats and of different sizes. As a simple example a 40-character address field versus a 160-character field. The data may also refer to the same model in different ways where one system 10, 15, 20 may create order codes consisting of color, model, manufacturer whereas another system 10, 15, 20 may create its own SKU for each product. The combinations and possibilities are endless, and in is sufficient to note that each of the formats will be different as the order enters the central messaging system 25 where it must be mapped 40 based on the client properties 45 and then mapped 50 to an internal format inside a vendor queue 55. The orders in the vendor queue 55 are also mapped to each of the formats required by the various vendor systems 60, 65, 70. Similarly to the client mapping done from the input systems with varying formats 10, 15, 20 the vendor systems 60, 65, 70 will also have differing input formats and requirements for order placement. The mapping function 40 takes the normalized orders from the order queue 35 and maps 40 these to the individual vendor systems 60, 65, 70.

Therefore, as input or output systems are changed, by modifying the interface layer 80, there can be cross compatibility with multiple systems. For example, if an input system is modified and the interface between the input system and the interface layer is then modified, that modification then automatically populates to correspond to each of the several output systems. In this way, a modification to the interface of one input system thus allows the input system to work with all output systems. Thus, the modification to how an TEM system works can be normalized by the interface 80, thus allowing carrier integrations without the need to individually integrate the input system which each carrier. The reverse is also true in that a modification to the carrier system can be interfaced with the interface layer software 80 which then causes each of the several TEM systems to work correctly with that carrier. Thus, the interface layer (e-bonding layer) and its associated software and mappings database/storage 85 allows for the change of one interface with an input to work with all outputs and the change of one interface with an output to work with all inputs, thus vastly saving the need to create a custom integration on a one by one basis for each input and output system combination. Changes to the communications system between input and output systems provided by the interface and particularly the interface layer and messaging system may be accomplished by modifying the mapping 85 data in the corresponding storage. By updating the mapping between interface and input and/or interface and output, the interface that already exists on the other side allows for all changed mappings to be correlated to each of the other sided changes to the system.

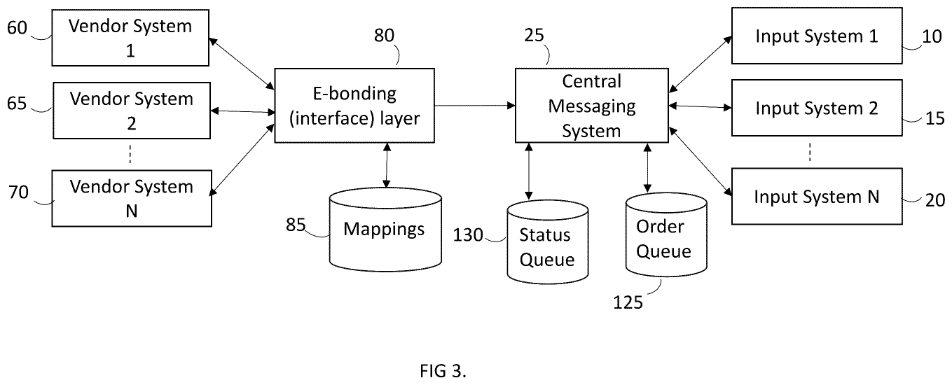

FIG. 3 shows a depiction of the response flow of order status information. In these cases, we show the multiple vendor systems 60, 65, 70 sending information to a central e-bonding layer 80 or interface system that normalizes the status using a mappings 85 database. The normalized status messages and order information is sent to the central messaging system 25 which also places the status updates in a status queue 30. The queue 30 is used in case the central messaging system 25 is unable to communicate immediately with the target input system being one of the input systems 10, 15, 20 shown in FIG. 3. There may also be a flow of status information which arrives faster than the system is able to dispatch it.

Again, it should be noted that while the FIG. 2 and FIG. 3 show 3 each of the input systems 10, 15, 20 and 3 each of the output systems 60, 65, 70, the system is capable of providing service to more such systems and the number of systems connected on either side is independent and unlimited.

Ideally the source input system provides an API for gathering the order information, but in some cases where such an API is not available or possibly if there is a software issue or outage, operators are also able to create orders directly into the order queue using their own direct order placement system. These orders may be phoned in, emailed in, or done over swivel chair systems. It is intended that this system be the exception and not the rule.

Similarly, the larger vendor systems 60, 65, 70 provide e-bonding interfaces to large TEM providers 190 and this simplifies the placement of orders. That said, in the case where systems are inoperable or an outage may be in process, the telecom expense management system 190 can also place orders indirectly into the order queue 160 by phoning in the order or in some cases placing it by email or through a secondary system.

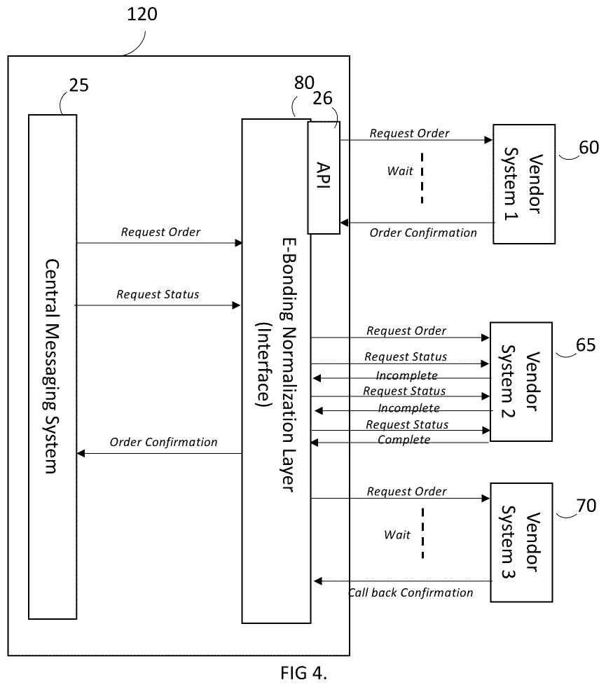

Turning now to FIG. 4, we see how the e-bonding vendor system interface normalized three example processes of order placement.

In looking at vendor system 60 we can see the flow of order entry from the central messaging system 25 that send the order request to the E-bonding Normalization layer 80 that translates and adapts the request to place the order into the Vendor system 60 using the appropriate method for the system.

Vendor system 60 accepts the order and works through an API Application Programming Interface 26 to receive the order and provide confirmation. It will respond when it is able to confirm the order. No other action is necessary, but there may not be any way of getting status or reporting that back to the originating system. Regardless, the central messaging system sends a consistent message to request the order and sends a consistent reply, regardless of the specifics surrounding the interface requirements of Vendor system 60.

Similarly, vendor system 65 accepts an order in a similar format, but this system does not reply directly with a confirmation. Instead, the E-Bonding normalization layer 80 must continue to poll requesting status from the Vendor system until it received the status that the order is confirmed. Once received, the central messaging system sends the confirmation back in a consistent way, again regardless of the specifics surrounding the interface requirements of Vendor system 65.

Similarly, vendor system 70 accepts an order in a similar format, but this system does not reply to the confirmation. Instead, a call back function is sent, and the e-bonding normalization layer must provide the entry point for the call back function in order to receive the confirmation. Once received, the central messaging system sends the confirmation back in a consistent way, again regardless of the specifics surrounding the interface requirements of Vendor system 70.

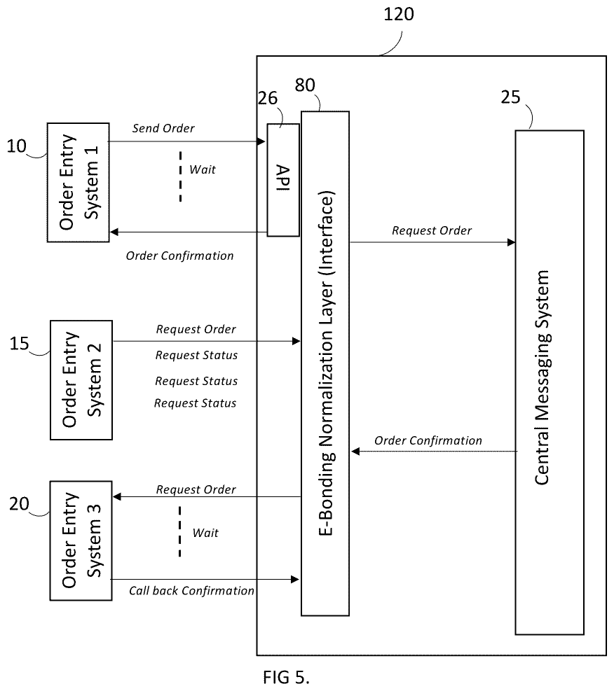

As a further illustration of the above, turning now to FIG. 5, we see a similar scenario showing how the Central Messaging System interface with the Order Entry systems takes place, again using three example processes of order placement.

In looking at order entry system again 10 we can see the flow of order entry from the central messaging system 25 works through an API 26 and receives the order request from the E-bonding Normalization layer 80 that translates and adapts the request to place the order into the order entry system 60 using the appropriate method for the system.

Order entry system 10 accepts the order and will do what it has to do responding when it is able to confirm the order. No other action is necessary, but there may not be any way of getting status or reporting that back to the originating system. Regardless, the E-bonding Normalization layer sends a consistent message to request the order and sends a consistent reply, regardless of the specifics surrounding the interface requirements of order entry system 10.

Similarly, order entry system 15 accepts an order in a similar format, but this system does not reply directly with a confirmation. Instead, the E-Bonding normalization layer 80 must continue to poll requesting status from the order entry system 15 until it received the status that the order is confirmed. Once received, the E-bonding Normalization layer system sends the confirmation back in a consistent way, again regardless of the specifics surrounding the interface requirements of order entry system.

Similarly, order entry system 20 accepts an order in a similar format, but this system does not reply to the confirmation. Instead, a call back function is sent, and the central messaging system must provide the entry point for the call back function in order to receive the confirmation. Once received, the E-bonding Normalization layer system sends the confirmation back in a consistent way, again regardless of the specifics surrounding the interface requirements of order entry system 20.

The above examples as three simple examples that show the value of the e-bonding normalization layer from the point of view of interfacing with the vendor side systems.

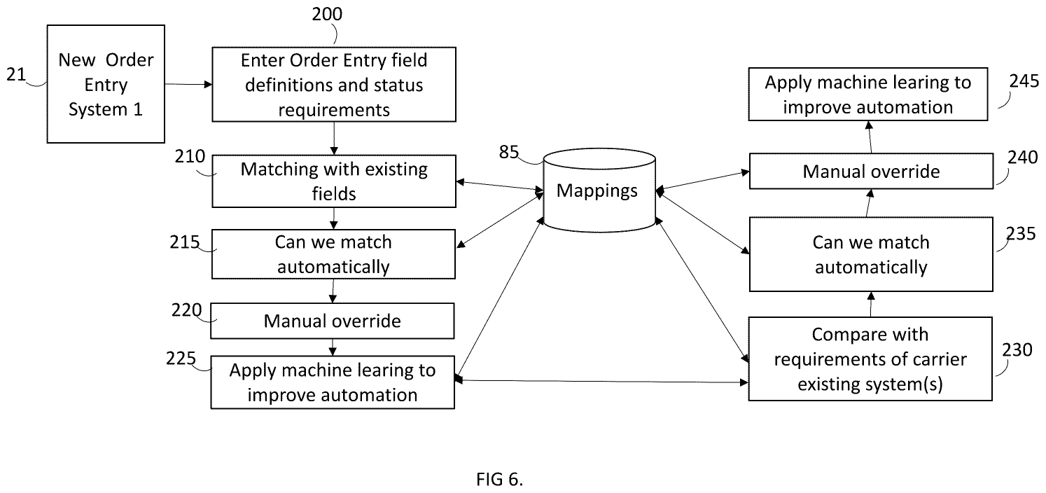

Turning now to FIG. 6, we see how an new E-Bonding/interface order entry system is configured to operate and interfaced to the system when a new input system is added.

The new order entry system 21 structure definitions provided for order entry are entered 200 into the system along with the expected status field requirements. The actual interface definition is done through a variety of known interface types such as a Rest API, Json, Soap, or other web interface. Here we are describing the data mapping functions only. The fields entered 200 are attempted to be matched 210 with the known mappings 85 and those that can be matched automatically 215 are done so whereas those that fail are matched manually 220. Machine learning 225 is applied to the manually added fields to improve automation in future integrations.

In addition, the carrier requirements of known and already interfaces target carrier systems is matched 230 to ensure that the new order entry system 1 has sufficient data in its adapted mapping 85 to satisfy the requirements of the target carrier system. Any newly added requirement fields are matched 235 and if a match cannot be found again manual override 240 is required and this data is used to train the machine learning 245 to improve future integrations. It should be noted that in addition to new fields being validated, it may also involve matching existing fields with adaptations. As an example, if a carrier required 40 characters for a field and the internal super set data in the mapping 85 includes 80, we always store 80 and truncate it. If the new system 21 used only 30, we may require an adaptation of adding 10 blank spaces. This is a simplistic example, and it only brought up to illustrate that the mappings used in part of the interface 200, 210, 215, 220, 225 may also affect what is done in the carrier integration part 230, 235, 240, 245. Furthermore, the service manager e-bonding system may be utilized to streamline order processing in that a customer may enter an order by providing limited information such as what new phone they want. The super set of data can be used by the service manager to supplement this order information to complete a valid order that is compatible with the various output e.g. carrier systems. For example, if an automated chat bot receives an order request from a particular phone number or referencing a particular phone number, instead of asking the customer for all the order information necessary to create a valid order output to the carrier system, the service manager can utilize the information in the super set of data to supplement the limited order information received to create an order that is compatible with the service provider system of the particular carrier/supplier in question.

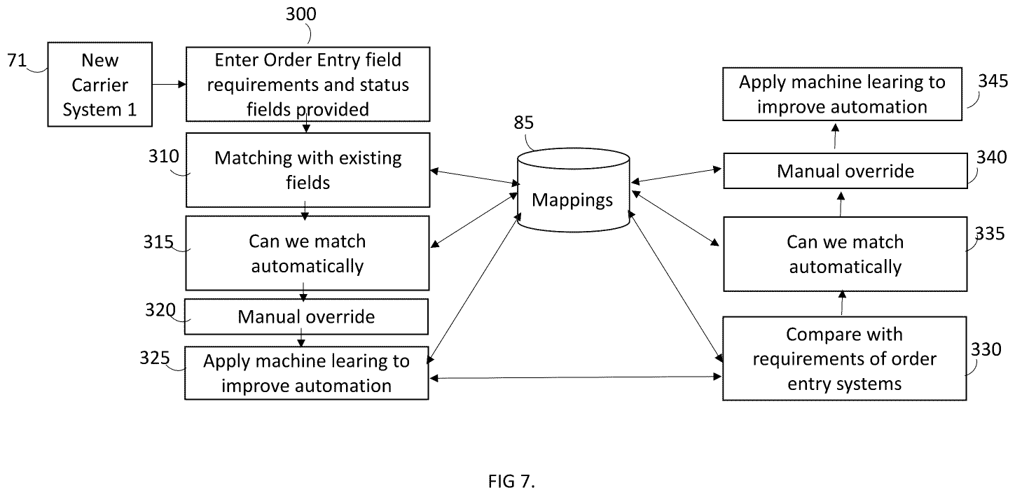

Turning now to FIG. 7, we see how a new E-Bonding/interface carrier system is also configured to operate and interfaced to the system when a new output system is added.

The new carrier system 71 structure definitions provided for order entry are entered 300 into the system along with the expected status field requirements. The actual interface definition is done through a variety of known interface types such as a Rest API, Json, Soap, or other web interface. Here we are describing the data mapping functions only. The fields entered 300 are attempted to be matched 310 with the known mappings 85 and those that can be matched automatically 315 are done so whereas those that fail are matched manually 320. Machine learning 325 is applied to the manually added fields to improve automation in future integrations.

In addition, the order entry requirements of known and already interfaces order entry systems are matched 330 to ensure that the new carrier system 71 has sufficient data in its adapted mapping 85 to satisfy the requirements of the existing order entry system s. Any newly added requirement fields are matched 335 and if a match cannot be found again manual override 340 is required and this data is used to train the machine learning 345 to improve future integrations. It should be noted that in addition to new fields being validated, it may also involve matching existing fields with adaptations. As an example, if an order entry system entered 40 characters for a field and the internal super set data in the mapping 85 includes 80, we always store 80 and truncate it. If the new system 71 uses only 30, we may require an adaptation of adding 10 blank spaces or deciding how we convert/map the new field to retain the most salient information. This is a simplistic example, and it only brought up to illustrate that the mappings used in the first part of the interface 300, 310, 315, 320, 325 may also affect what is done in the order entry integration part 330, 335, 340, 345.

There are also exceptions which are accounted for by the system. Take an example of an order for a discontinued device, while the source order entry system may still have the device listed as available as it has not synchronized with the carrier system for the latest inventory. In such cases, exception conditions are provided with errors requiring the order to be rejected and reentered with a different device selection.

Similarly, if a device goes on backorder after the order has been placed, an exception condition giving the user the choice to change the device on order or to wait on backorder is given.

Many more such exception conditions as handled as part of the flow, and the system applies machine learning to improve its capability to both resolve exceptions on its own or to improve the selections provided to the user.

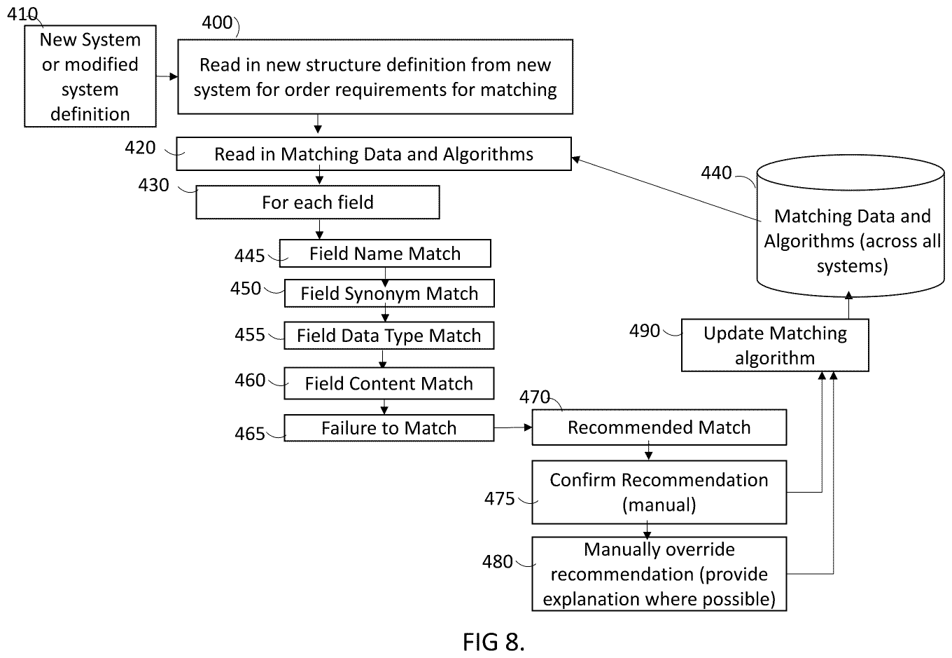

Turning now to FIG. 8. We see some examples of machine learning used to improve the automation steps.

A new system 410 or modified system definition is detected, and the new structure definition is read in 400. The existing matching algorithms and data 440 is read in 420 in preparation for processing.

For each of the new 430 fields read from 410 the system looks to do comparison matching. If a field name 445 is matched or an existing synonym is found 450 the field is easily matched and mapped to the known data to generate invoices or read statuses from the new system.

Fields data type 455 matching is also attempted using masks or other known data type comparisons. For example, the system may know that a phone number for the US can be 10 digits with the prefix or 13 digits with the country code. The system can also apply known masks to the phone numbers that employ separating the digits in a known format using brackets, dashes or dots. Similarly zip codes can be 5 digits, or 5 digits followed by a dash and 4 more digits. Similar masks can be applied for other fields. The matching algorithms used also keep track of known data from carriers such as the formats they use for customer codes, order codes, and product codes. This can help facilitate matching.

Field content 460 matching is also used to derive. For example, if a field for city is defined, and the system read data such as known city names we can reliably make or suggest a match. If a manufacturer name is expected and the system read known names of manufacturers, the system can also reliably suggest a match.

If the system fails 465 to match it can narrow down the possibilities from the remaining fields that are close or similar in data type or content. For example, numeric or alphanumeric fields, field length, or content can be used to make a best effort guess. This recommendation 470 may be confirmed 475 or overridden 480 by the operator.

Further additional explanations 480 can be provided by the operator to enhance the system. For example, if a new field match for purchase order is made using a field name of acquisition code. The operator can add acquisition code as a new synonym for purchase order to the system to improve the updating or matching algorithms. Further, if the system detects that 5 of the last 6 matches using a field of 10 numeric digits was made for purchase order, it will adapt its recommendations to match this type of field to purchase order in the future.

If the confidence in the match is high, the matching algorithm may also adapt the synonym matching automatically so that the matching is made automatically without manual intervention.

It should be noted that the examples in FIG. 8 above can apply to both the input order entry systems or the output carrier systems for orders and status collection. A generic method of matching fields and data to each interface is applies and machine learning is applied to each on an individual basis. In some cases, the system is able to leverage learned data from one system to the other also. Take for example the case where a new carrier system refers to the location of the order as ‘order originator’ for example. We may match this data from the input system where we accept new orders and later when looking at status data also leverage this learned matching data to quickly match ‘order originator’ to our internal location fields for status and other such data structures coming from this new carrier system.

Although the invention has been described with reference to a particular arrangement of parts, features, and the like, these are not intended to exhaust all possible arrangements or features, and indeed many other modifications and variations will be ascertainable to those of skill in the art.

What is claimed is:

1. A system for multiple input and output system interfacing for telecommunications services and devices comprising:
a computer having interface software executing thereon which is in communication with software of a plurality of input systems which input systems each relate to a telecommunications expense management (TEM) system and which is in communication with software of a plurality of output systems which output systems each relate to a telecommunications service provider system;
the software of each input system provides access to a TEM computer which provides user access for procuring telecommunications devices and telecommunications service plans;
the software of each output system is interfaced with a telecommunications service provider computer which fulfills telecommunications device and/or service orders;
wherein upon modification of the interface software with an input change for the input system due to a change to the software of one or more of the input systems, said interface software automatically interfaces with each output system such that each of the output systems is compatible with the input change such that information from the input system subject to the input change is converted by the interface software to be compatible with each output system; and
wherein upon modification of the interface software with an output change due to a change to the software of one or more of the output systems, said interface software automatically interfaces with each input system such that the input system is compatible with the output change such that information from the output system subject to the output change is converted by the interface software to be compatible with each input system.

2. The system of claim 1 wherein the input change allows the service provider computers to communicate with the TEM computer in a form matched to that TEM computer.

3. The system of claim 1 wherein the input change allows the service provider computers to communicate with the TEM computer in a form matched to that TEM computer.

4. The system of claim 1 wherein the information from the input system is indicative of a telecommunications device or service order.

5. The system of claim 1 wherein the information from the output system is indicative of a confirmation for a telecommunications device or service order.

6. The system of claim 1 wherein the information from the input system is indicative of request to modify a telecommunications service plan.

7. The system of claim 1 wherein the interface software is configured to access a mapping storage having mapping data which mapping data indicates how data received from each input system is correlated to data to be sent to each output system.

8. The system of claim 7 wherein the input change results in a modification to the mapping data.

9. The system of claim 1 wherein the interface software further comprises messaging software which provides a status queue and order queue for statuses and orders which are to be sent to the corresponding one(s) of the plurality of input and output systems, the messaging software correlating the received statuses and orders to the appropriate component of the interface software.

10. A system for interfacing a telecommunications expense management (TEM) input system with a plurality of telecommunications service provider output systems comprising:
an interface computer in communication with a telecommunications expense management (TEM) computer and a plurality of service provider computers, the interface computer comprising software executing thereon which software provides a communications interface between the TEM computer and each of the service provider computers to allow inputs into the TEM computer for one or more of the service provider computers to be received by the interface computer and transmitted to one or more of the service provider computers in a form matched to the service provider computer receiving the input(s) such that a change to the communications interface between the TEM computer and the interface computer allows the TEM computer to communicate with each of the service provider computers in the form matched to that service provider computer.

11. The system of claim 10 wherein the change to the communications interface between the service provider computer and the interface computer allows the service provider computers to communicate with the TEM computer in a form matched to that TEM computer.

12. The system of claim 10 wherein the inputs from the input system are indicative of a telecommunications device or service order.

13. The system of claim 10 wherein the interface software is configured to access a mapping storage having mapping data which mapping data indicates how data received from each input system is correlated to data to be sent to each output system.

14. The system of claim 13 wherein the change to the communications interface results in a modification to the mapping data.

15. A system for interfacing a telecommunications service provider output system with a plurality of telecommunications expense management (TEM) input systems with comprising:
an interface computer in communication with a plurality of telecommunications expense management (TEM) computers and a service provider computer, the interface computer comprising software executing thereon which software provides a communications interface between the TEM computers and the service provider computer to allow inputs into the TEM computer for one or more of the service provider computers to be received by the interface computer and transmitted to one or more of the service provider computers in a form matched to the service provider computer receiving the input(s) such that a change to the communications interface between the service provider computer and the interface computer allows the TEM computer to communicate with each of the service provider computers in the form matched to that service provider computer.

16. The system of claim 15 wherein the change to the communications interface between the TEM computers and the interface computer allows the TEM computers to communicate with the service provider computer in a form matched to that service provider computer.

17. The system of claim 15 wherein the inputs from the input system are indicative of a telecommunications device or service order.

18. The system of claim 15 wherein the interface software is configured to access a mapping storage having mapping data which mapping data indicates how data received from each output system is correlated to data to be sent to each input system.

19. The system of claim 18 wherein the change to the communications interface results in a modification to the mapping data.
